(19) United States
(12) Patent Application Publication
(10) Pub. No.: US 2013/0146779 A1
(43) Pub. Date: Jun. 13, 2013

(54) Micro Ion Chamber

(71) Applicant: Alex Deyhim, Ithaca, NY (US)

(72) Inventor: Alex Deyhim, Ithaca, NY (US)

(21) Appl. No.: 13/373,986

(22) Filed: Dec. 7, 2011

(51) Int. Cl. G01T 1/16

(52) U.S. Cl. 250/374

(57) ABSTRACT

A micro sized ionization chamber that serves as a radiation detector for use in hard X-ray beamline applications. It is the simplest of all devices in this category. The small size allows for closer placement to the sample being measured, without sacrificing the accuracy and componentry of a larger sized, gas filled ionization chamber.

### CROSS REFERENCE TO RELATED APPLICATIONS

Not applicable

### STATEMENT REGARDING FEDERALLY SPONSORED RESEARCH OR DEVELOPMENT

Not Applicable

### SEQUENCE LISTING OR PROGRAM

Not Applicable

### BACKGROUND OF THE INVENTION

An ionization chamber is a gas filled chamber that serves as a radiation detector. It is the simplest of all devices in this category and detects or measures ionizing radiation. The device described herein is for use in beamline applications.

### SUMMARY OF THE INVENTION

The Micro Ion Chamber is a small ionization chamber detector whose purpose is to monitor the intensity of hard X-ray beams used in Synchrotron facilities. The housing is constructed of stainless steel. The unique feature of this chamber is its small dimensions, making it possible to place the chamber extremely close to the sample.

The electrodes used in this Micro Ion Chamber are constructed of nickel plated copper on fiberglass supports, all housed within a nickel plated aluminum frame. The high voltage electrode is connected to a SHV, safe high voltage, connector. The low voltage electrodes are connected to BNC, Bayonet Neill-Concelman, connectors.

### BRIEF DESCRIPTION OF DRAWINGS

The invention as described herein with references to subsequent drawings, contains similar reference characters intended to designate like elements throughout the depictions and several views of the depictions. It is understood that in some cases, various aspects and views of the invention may be exaggerated or blown up (enlarged) in order to facilitate a common understanding of the invention and its associated parts.

FIG. 1 is a schematic of the micro ion chamber.

FIG. 2 is a schematic of the micro ion chamber in the horizontal direction.

FIG. 3 is a schematic of the micro ion chamber in the vertical direction.

FIG. 4 is a schematic of the micro ion chamber in the vertical direction; opposite side.

FIG. 5 is a schematic of the low voltage electrode.

FIG. 6 is a schematic of the high voltage electrode.

### DETAILED DESCRIPTION OF INVENTION

Provided herein is a detailed description of one embodiment of the invention. It is to be understood, however, that the present invention may be embodied with various dimensions. Therefore, specific details enclosed herein are not to be interpreted as limiting, but rather as a basis for the claims and as a representative basis for teaching one skilled in the art to employ the present invention in virtually any appropriately detailed system, structure, or manner.

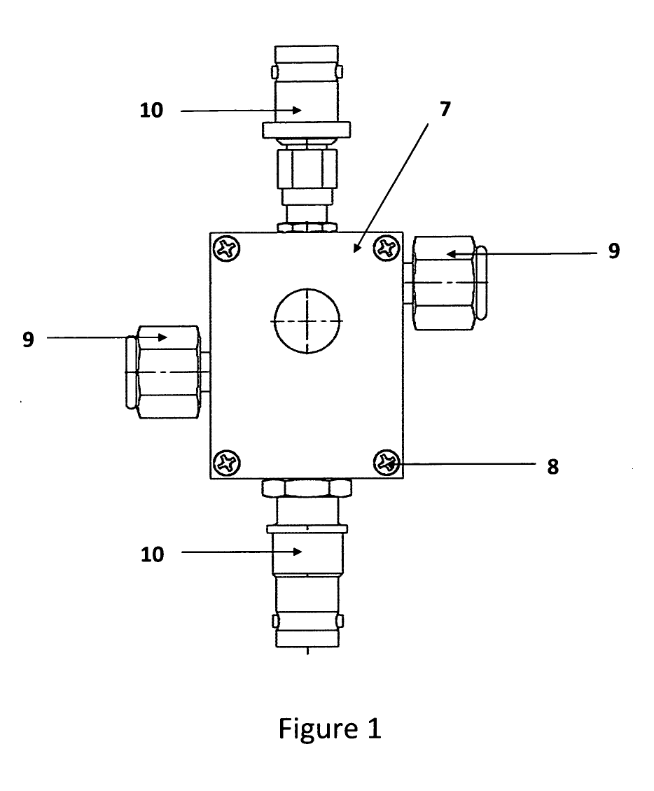

FIG. 1 represents the overall chamber design. The purpose of this chamber is to monitor the intensity of hard X-ray beams used in Synchrotron facilities. The shell 7 of the chamber is designed out of stainless steel and secured with a total of eight screws 8, four per side. Also visible in FIG. 1 are the two Colder MCD1002 ¼″ hose ‘push-to-connect’ normally closed valved gas connectors 9. These are for use in all applications. The insert a Colder MCD2202 ⅛″ hose barb non-valved in-line couplings 10, are also visible.

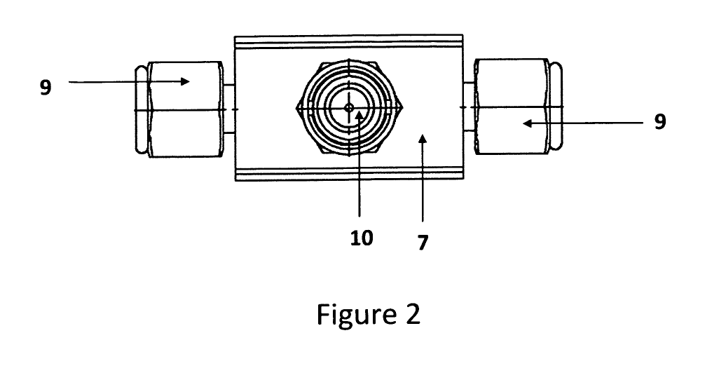

FIG. 2 shows the side view of the micro ion chamber in the horizontal direction. Visible on this schematic is the shell 7 of the chamber, constructed out of stainless steel, as previously described. Also, the Colder MCD 1002 ¼″ hose ‘push-to-connect’ gas connectors 9 and Colder MCD 2202 ⅛″ hose barb non-valved in-line couplings 10, which are included and used in all applications of the micro ion chamber.

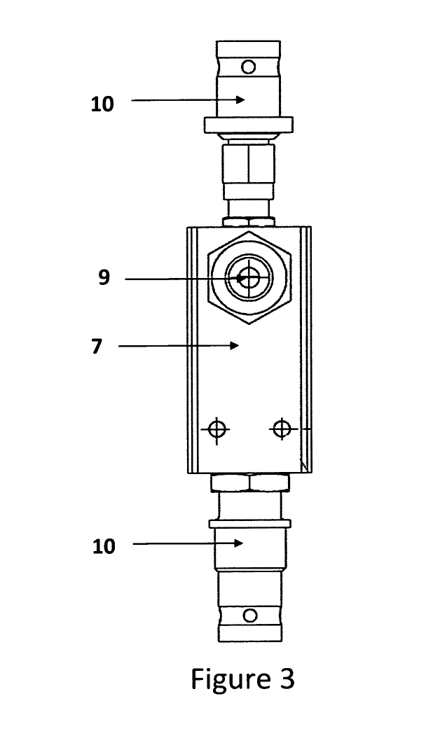

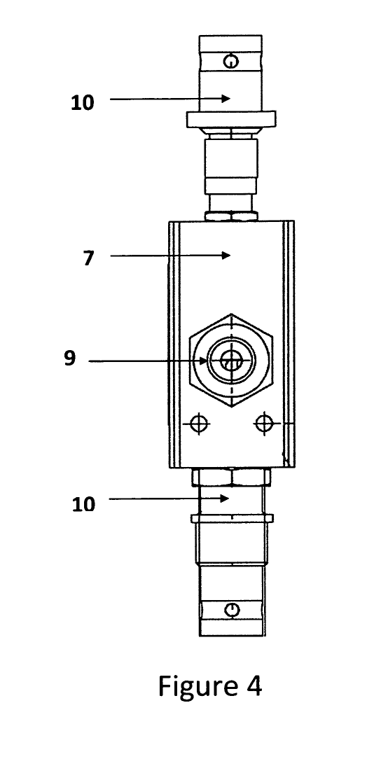

FIGS. 3 and 4 show the micro ion chamber in the vertical direction. These figures show the housing 7, Colder MCD 1002 ¼″ hose ‘push-to-connect’ gas connectors 9 and Colder MCD 2202 ⅛″ hose barb non-valved in-line couplings 10, which are included and used in all applications of the micro ion chamber. Since the chamber itself is a simple design, the additional figures are simply to show the overall chamber from several angles.

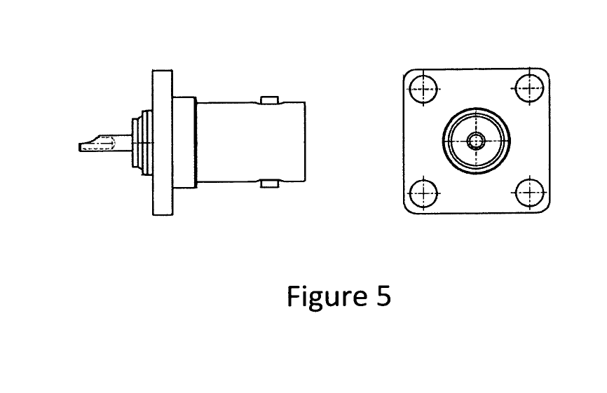

FIG. 5 is a schematic of the low voltage electrode. The electrode used is a Huber & Suhner part number 22540355 Female BNC Panel Mount connector with a nominal impedance of 50 Ohms to connect with the low electrode. The low voltage electrode is constructed of nickel plated copper on fiberglass supports.

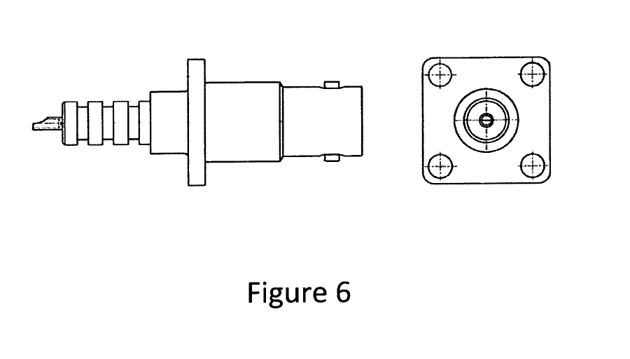

FIG. 6 is a schematic of the high voltage electrode. The electrode connects through a Huber & Suhner part number 22542010, SHV RF Panel Mount connector with a nominal impedance of 50 Ohms. The high voltage electrode is constructed of a nickel plated copper on fiberglass supports.

What is claimed is:

1. An ion chamber comprising:
(a) A housing;
(b) A low voltage electrode;
(c) A high voltage electrode;
(d) Two gas connectors;
(e) And two non-valved in-line couplings.

2. The apparatus of claim 1 wherein said ion chamber housing is composed of stainless steel.

3. The apparatus of claim 2 wherein said housing is secured with eight screws, four per side.

4. The apparatus of claim 1 wherein said low voltage electrode is comprised of nickel plated copper on fiberglass supports.

5. The apparatus of claim 4 wherein said low voltage electrode uses a Huber & Suhner female BNC Panel Mount connector.

6. The apparatus of claim 1 wherein said high voltage electrode is comprised of nickel plated copper on fiberglass supports.

7. The apparatus of claim 6 wherein said high voltage connector uses a Huber & Suhner SHV RF Panel Mount connector.

8. The apparatus of claim 1 wherein said gas connectors are Colder ¼″ hose ‘push-to-connect’ type.

9. The apparatus of claim 1 wherein said non-valved in-line coupling is a Colder ⅛″ hose barb type.

10. The apparatus of claim 1 wherein said ion chamber is 20 mm along the beam direction and 30 mm perpendicular to it.

11. The apparatus of claim 10 wherein said ion chamber has a sparking voltage is approximately 5500V under the atmospheric environment.

12. The apparatus of claim 10 wherein said ion chamber has a leakage rate of gas less than 2 torr per five minute intervals under a 10 torr vacuum environment.

13. The apparatus of claim 10 wherein said ion chambers small dimensions allow for placement closer to the sample being measured for increased accuracy.
